(19) United States
(12) Patent Application Publication
(10) Pub. No.: US 2017/0289081 A1
(43) Pub. Date: Oct. 5, 2017

(54) Systems and Methods For Periodic Posthumous Electronic Delivery of Voice Messages, Video Messages, Images, or Email on Selected Occasions

(71) Applicant: Peter J. Barrett, Houston, TX (US)

(72) Inventor: Peter J. Barrett, Houston, TX (US)

(21) Appl. No.: 15/473,014

(22) Filed: Mar. 29, 2017

Related U.S. Application Data
(60) Provisional application No. 62/315,783, filed on Mar. 31, 2016.

(51) Int. Cl. H04L 12/58

(52) U.S. Cl. CPC H04L 51/10; H04L 51/08; H04L 51/02

(57) ABSTRACT

A system for periodically transmitting posthumous messages from an originator to a recipient stores a message from the originator to the recipient. The message may have a digital attachment including video, audio, or an image. A selected date, which may correspond to a particular occasion, is stored for delivery of the stored message to the recipient when the originator is determined to be deceased. The system automatically transmits the stored message to the recipient periodically on the selected date unless halted by the recipient.

### CROSS REFERENCE TO RELATED APPLICATION

This application claims priority to U.S. Provisional Patent Application Ser. No. 62/315,783, filed Mar. 31, 2016, for “Systems and Methods for Periodic Posthumous Electronic Delivery of Voice Messages, Video Messages, Images or Email On Selected Occasions.”

### FIELD OF INVENTION

The present invention relates in general to electronic messaging techniques and in particular to systems and methods for periodic posthumous electronic delivery of voice messages, video messages, images, and/or email on selected occasions.

### BACKGROUND OF INVENTION

A number of systems are available for helping grieving family and friends through the posthumous transmission of pre-recorded video, voice, and/or email messages. However, these existing systems are subject to a number of significant disadvantages. Among other things, currently available posthumous messaging systems only implement a single delivery event, whether to single or multiple parties. In addition, the existing systems do not provide the receiving parties the ability to selectively stop and restart message delivery and provide only limited in the control over the selection of triggering events. Finally, no other systems hold all message artefacts (voice, photos and video) internal to their systems, giving the opportunity to find such artefacts before the creator desired them to be viewed.

### SUMMARY OF INVENTION

The principles of the present invention are embodied in systems and methods for periodically delivering electronic messages, such as text messages and emails, which include a digital attachment, such as video, voice, and/or images (photos). These messages are sent “perpetually” on a specified date (day/month) to pre-determined recipients after the death of the originator. The service is preferably Internet-based.

In one preferred embodiment, the originator sets up an account in which the originator specifies which people should receive messages (“recipients”). For each recipient, the originator can specify one or multiple dates on which that receiving party will receive emails (with or without attachments). The delivery date is selected by the month and day to allow unique messages to be sent annually (for example on a birthday or wedding anniversary).

Preferably, each recipient has an account set up through the originator, which allows for email address and text delivery number changes, as well as provides the recipient with the ability to turn on or off the delivery of messages. When the recipient's service is turned off no messages are delivered until the service is turned on again. At the point of being turned on again, all messages intended to be delivered up to the current date can be accessed. Preferably, future messages can never be retrieved by a recipient until the selected delivery date (day/month/year) is reached.

Embodiments of the inventive principles allow the originator to compose emails, and record voice or video (voice and moving image) messages directly into the system. Digital attachments may also be uploaded provided that they adhere to recognized file types. Each email and corresponding digital attachment is preferably for one date (day/month/year) such that the originator may prepare a unique custom message for each year for the rest of the recipient's expected life.

The preferred embodiments also offer the originator multiple ways for verification of passing and the triggering of message delivery. For example, a nominee such as a relative, friend, or legal representative may trigger message delivery. In another embodiment, a monthly message is sent via email, text message or phone call to the originator, requiring a response within a predetermined response period. For example, after three consecutive months of no-response, a final message is sent warning that the message delivery is about to be activated. If there is no-response to the final warning, the originator is considered to have passed, which triggers the sending of messages (e.g., emails text messages) informing the recipients that posthumous message delivery has been set up for them and that posthumous message delivery will occur when the appropriate dates are reached.

Once posthumous message delivery has been triggered, recipients are required to log in, confirm identity, and/or given the opportunity to update their details and turn posthumous message delivery off (which is preferably on by default). (It is possible that a user of the system may be both an originator and a recipient, since persons may not be aware of recipient status until the passing of the appropriate originator is confirmed.)

Advantageously, because all artifacts being left by the originator are maintained internal to the system, they can only be accessed by the receiving party in accordance with the instructions left by the originator upon the originator's death. Other than selecting whether or not to receive posthumous messages, the distribution of messages, including the image, audio, and video artifacts, is under control of the automated system executing the originator's instructions. End users therefore cannot access messages early. In addition, because the system is automated, message delivery can continue indefinitely after the originator's death.

### BRIEF DESCRIPTION OF DRAWINGS

For a more complete understanding of the present invention, and the advantages thereof, reference is now made to the following descriptions taken in conjunction with the accompanying drawings, in which:

FIG. 1 is a high-level diagram illustrating the primary subsystems of a posthumous message delivery system embodying the principles of the claimed invention;

FIG. 2A is a high-level diagram illustrating the primary functional blocks of the front end web interface shown in FIG. 1;

FIG. 2B is a flowchart illustrating the overall operation of the My Account functional block of FIG. 2A in detail;

FIG. 2C is a flowchart illustrating the operation of the Message Option block of FIG. 2B in further detail;

FIG. 2D is a flowchart illustrating the operation of the Add Subscription block of FIG. 2B in further detail;

FIG. 2E is a flowchart illustrating the operation of the Create Receiver Profile block of FIG. 2D in further detail;

FIG. 2F is a flowchart illustrating the operation of the Create Event block of FIG. 2D in further detail;

FIG. 2G is a flowchart illustrating the operation of the Enter Data block of FIG. 2D in further detail;

FIG. 2H is a flowchart illustrating the operation of the Enter Message block of FIG. 2G in further detail;

FIG. 2I is a flowchart illustrating the operation of the Current Subscriptions block of FIG. 2B in further detail;

FIG. 2J is a flowchart illustrating the operation of the Edit Profile block of FIG. 2B in further detail;

FIG. 2K is a flowchart illustrating the operation of the Pricing functional block of FIG. 2A;

FIG. 2L is a flowchart illustrating the operation of the Terms and Conditions functional block of FIG. 2A;

FIG. 2M is a flowchart illustrating the operation of the About functional block of FIG. 2A;

FIG. 2N is a flowchart illustrating the operation of the Contact functional block of FIG. 2A;

FIG. 3A is a high-level diagram illustrating the primary functional blocks of the Automated System subsystem shown in FIG. 1;

FIG. 3B is a flowchart illustrating the operation of the Check For Emails To Be Sent functional block of FIG. 3A;

FIG. 3C is a flowchart illustrating the operation of Check Subscriber Status functional block of FIG. 3A;

FIG. 3D is a flowchart illustrating the operation of Email block of FIG. 3C in further detail;

FIG. 3E is a flowchart illustrating the operation of the Text block of FIG. 3C in further detail;

FIG. 3F is a flowchart illustrating the operation of the Nominee Notification block of FIG. 3C in further detail;

FIG. 3G is a flowchart illustrating the operation of the Provide Backend Notifications functional block of FIG. 3A;

FIG. 4A is a high-level diagram illustrating the primary functional blocks of the Administrative Backend subsystem shown in FIG. 1;

FIG. 4B is a flowchart illustrating the operation Create Vouchers functional block of FIG. 4A;

FIG. 4C is a flowchart illustrating the operation Check Data functional block of FIG. 4A; and

FIG. 4D is a flowchart illustrating the operation of the Run Reports functional block of FIG. 4A.

### DETAILED DESCRIPTION OF THE INVENTION

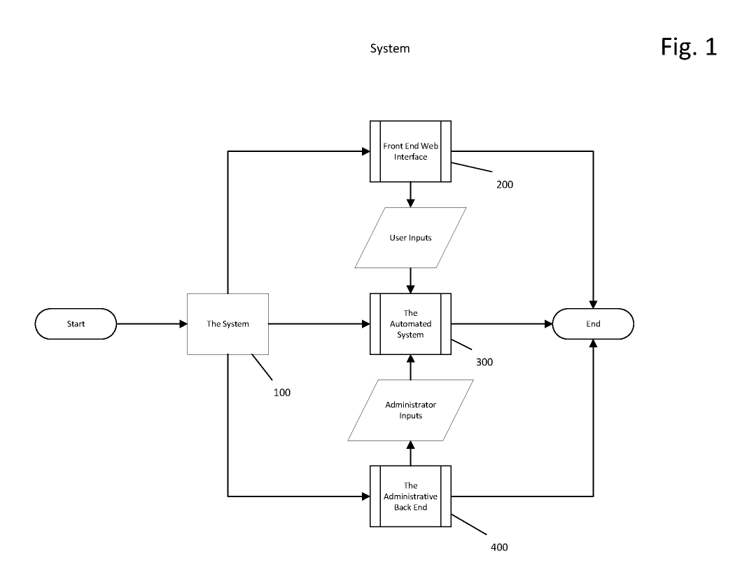

The principles of the present invention and their advantages are best understood by referring to the illustrated embodiment depicted in FIGS. 1-4 of the drawings, in which like numbers designate like parts.

FIG. 1 is a diagram of a preferred posthumous message delivery system 100 according to the principles of the present invention. The illustrated embodiment of Posthumous Message Delivery System 100 includes a Front End Web Interface Subsystem 200, which provides user inputs to Automated System subsystem 300, and an Administrative Back End subsystem 400, which also provides inputs to Automated System subsystem 300. Each of these subsystems is described in further detail below.

Front End Web Interface 200 supports access to system 100 by the end users through a set of end user terminals. Exemplary end user terminals include tablet computers (e.g., an Apple iPad, Microsoft Surface), smart phones (e.g., an Apple iPhone, Android), laptop or desktop personal computers, or other devices or systems capable of presenting a front end web page generated by system 100 to the end users and receiving and transmitting user inputs back to system 100.

The end user terminals communicate with system 100 across a public or private network, such as the Internet in the preferred embodiment, and a corresponding set of communications links. The communications links may be, for example, hardwired communications links such as DSL, or wireless communications links such as WiFi links, wireless wide area network (WAN) links, or cellular telephone links.

Automated System 300 is preferably based on one or more servers, input/output and communications subsystems, and a database 110. Automated System 300 receives end user inputs and presents information to the end users through Front End Web Interface 200. Software running on Automated System 300 executes the operations discussed in detail below. Automated System 300 also receives administrator inputs from Administrative Back End 400 and executes the administrative operations, also discussed in detail below.

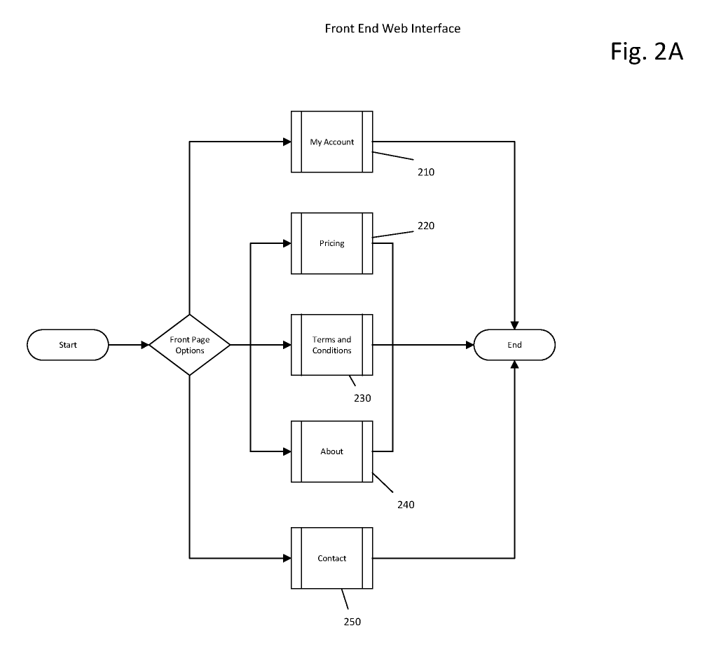

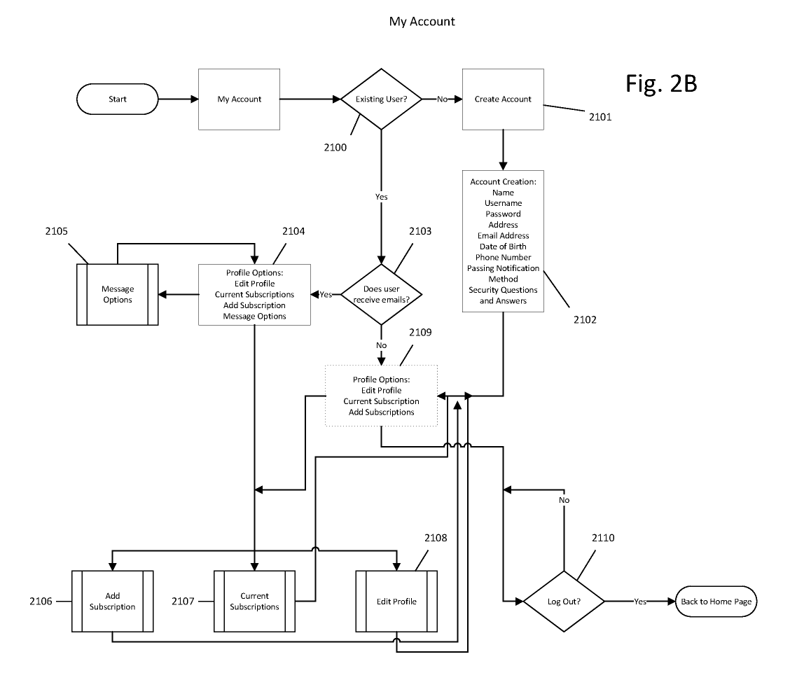

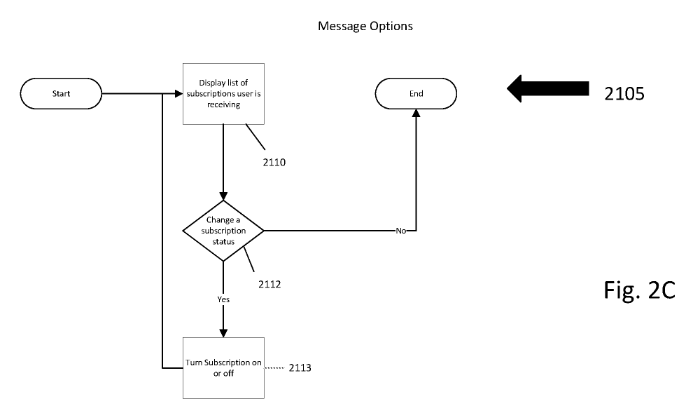

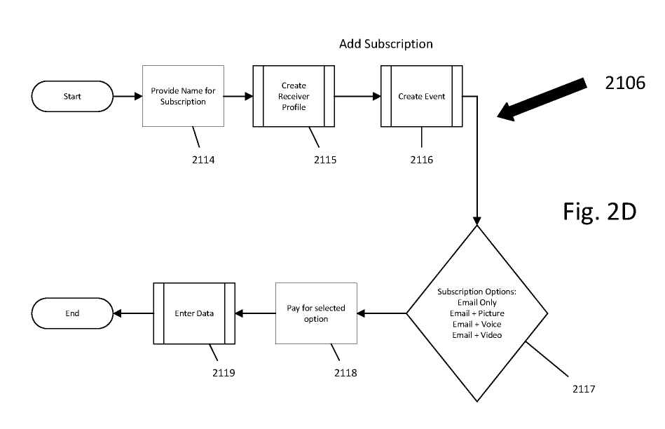

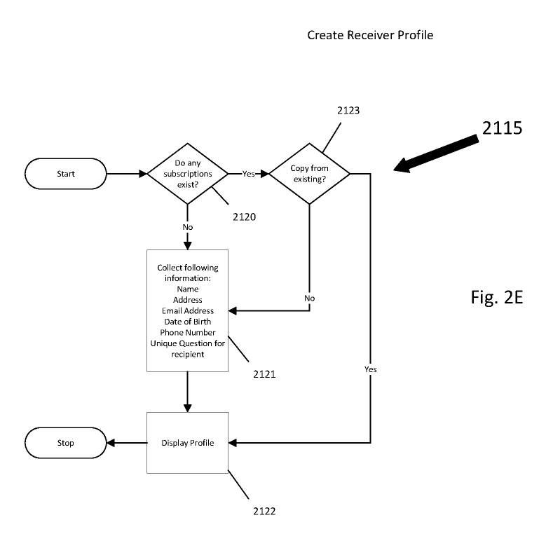

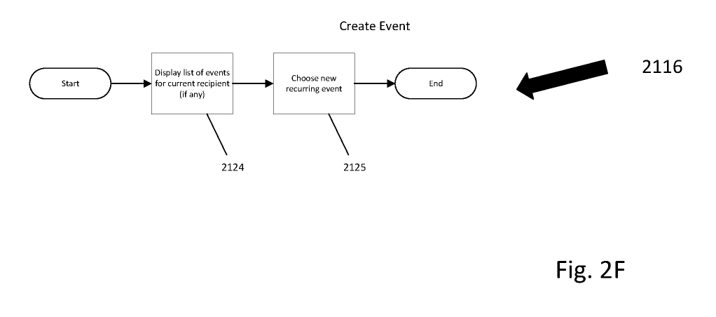

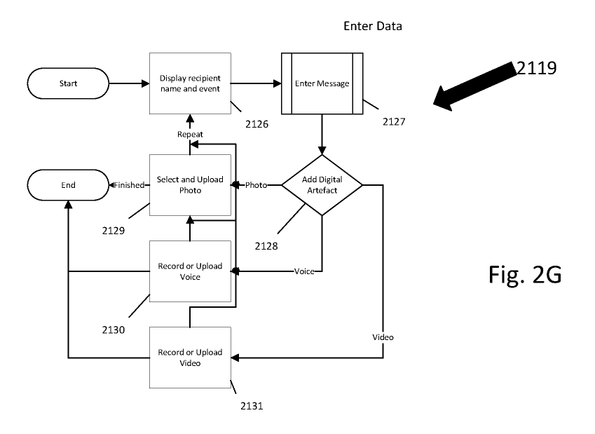

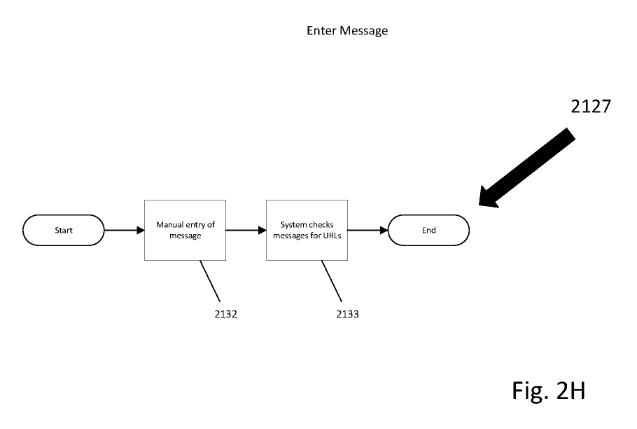

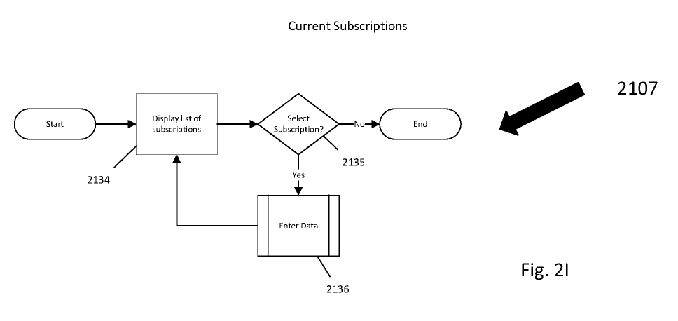

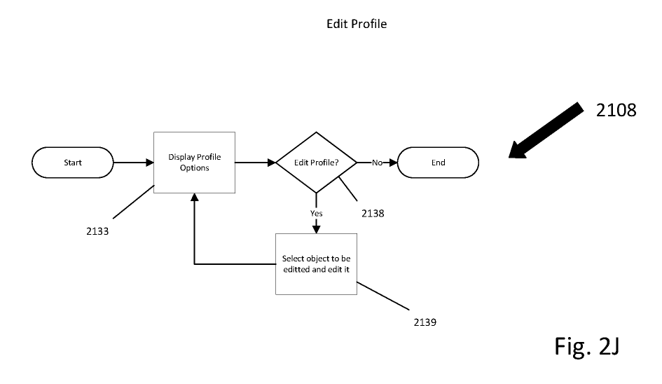

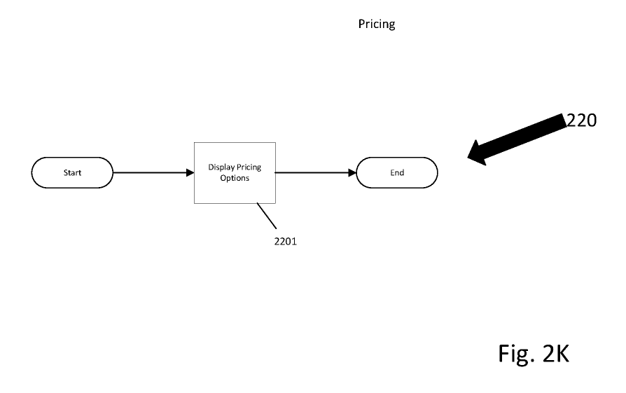

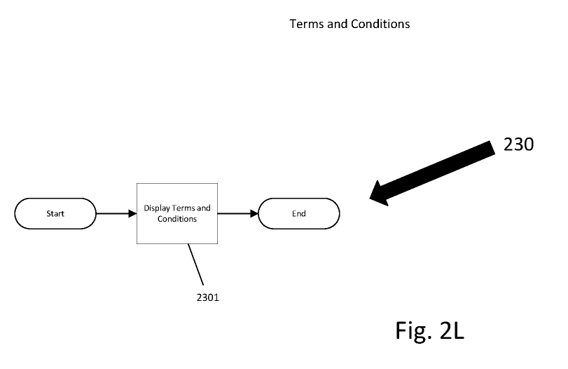

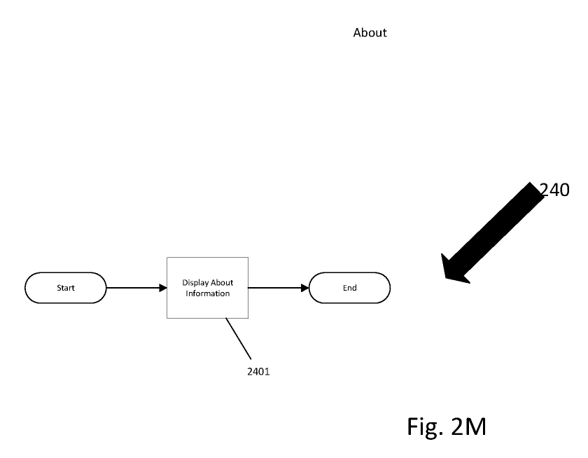

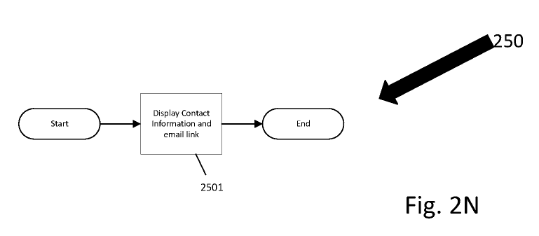

FIG. 2A depicts the primary functional blocks of Front End Web Interface Subsystem 200 of Posthumous Message Delivery System 100. Front End Web Interface Subsystem 200 includes My Account functional Block 210, Pricing functional block 220, Terms and Conditions functional block 230, About functional block 240, and Contact functional block 250.

The primary operations of My Account functional Block 210 are shown in further detail in the flow chart of FIG. 2B. At decision Block 2100, new (non-existing) originators can select a create account option 2101, which allows the originator to create an originator account. Account creation includes entry of originator particulars such as username and password, physical address, email address, date of birth, phone number, passing notification method, and security questions and answers.

For an existing user (originator or recipient), a determination is made at decision Block 2103 as to whether the user receives email. If so, the profile options available at Block 2104 include Message Options (Block 2105), Add Subscription (Block 2106), Current Subscriptions (Block 2107), and Edit Profile (Block 2108). For new users and users not receiving email, the profile options available at Block 2109 include Add Subscription (Block 2106), Current Subscriptions (Block 2107), and Edit Profile (Block 2108). The user logs out at Block 2110.

FIG. 2C depicts Message Options Block 2105 of FIG. 2B in further detail. A list of subscriptions the user is receiving is displayed at Block 2110. The default option is for a recipient to receive delivered messages, unless a change is made at Block 2112. At Block 2113, the user can turn on a subscription that is currently off or turn off a subscription that is currently off.

FIG. 2D illustrates the Add Subscription Block 2106 of FIG. 2B in further detail. A name is provided for the subscription (Block 2114), a receiver profile is created (Block 2115), and an event, such as a birthday or anniversary, is created (Block 2116). At Block 2117, subscription options are provided, including email only, email and picture, email and voice, and email and video. The user pays for the selected option at Block 2118 and the data is entered at Block 2119.

The Create Receiver Profile of FIG. 2D (Block 2115) is shown in further detail in FIG. 2E. At decision Block 2120, a determination is made as to whether any subscriptions exist. If not, then information is collected at Block 212, including, for example, name, address, email address, date of birth, phone number, and unique questions for recipient. The profile is then displayed at Block 2122. When an existing Block does exist, then the necessary information is copied from the existing subscription (Block 2123).

FIG. 2F shows Create Event Block 2116 of FIG. 2D in further detail. A list of events for the current recipient are displayed at Block 2124 and a new recurring event is chosen at Block 2125.

Enter Data Block 2119 of FIG. 2D is shown in further detail in FIGURE G. At Block 2126, the name of the recipient and the event are displayed. The message is entered at Block 2127 and the originator is provided the option of adding a digital artifact at Block 2128. The originator can upload one or more photos (Block 2129), record or upload voice (Block 2130), or record or upload video (Block 2131).

Enter Message Block 2127 of FIG. 2G is shown in further detail in FIG. 2H. At Block 2132, the message is manually entered and the message is check for URLs at Block 2133.

FIG. 2I shows Current Subscriptions Block 2107 of FIG. 2B is further detail. At Block 2134, a list of current subscriptions is displayed allowing a particular subscription to be selected at decision Block 2135. The data for the selected subscription is entered at Block 2136.

Edit Profile Block 2108 of FIG. 2B is shown in further detail in FIG. 2J. Profile options are displayed at Block 2137 and an edit profile option is made available at Block 2138. At Block 2139, the object to be edited is selected and edited.

Pricing Block 220 of FIG. 2A includes the display of pricing options of Block 2201 of FIG. 2K. Terms and Conditions Block 230 of FIG. 2A includes the display of site terms and conditions shown in Block 2301 of FIG. 2L. About Block 240 (FIG. 2A) includes displaying the About information in Block 2401 of FIG. 2M. Contact Block 250 (FIG. 2A) includes displaying contact information in Block 2501 of FIG. 2N.

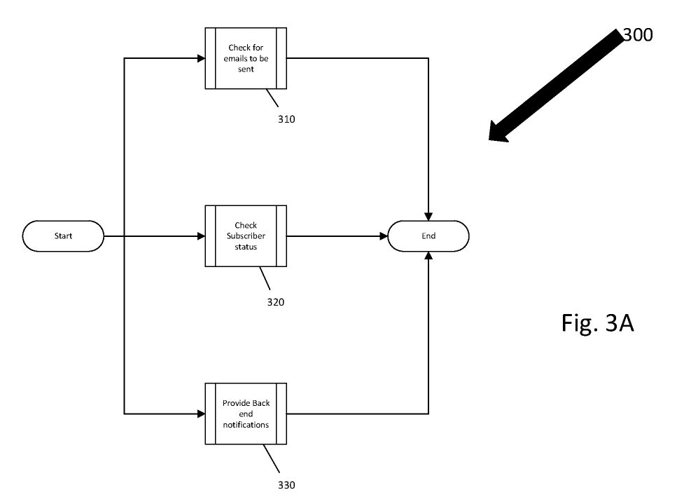

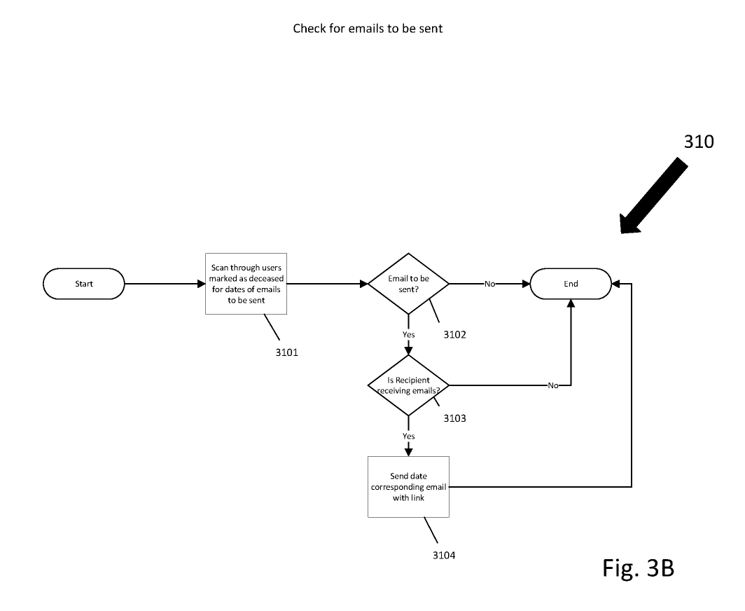

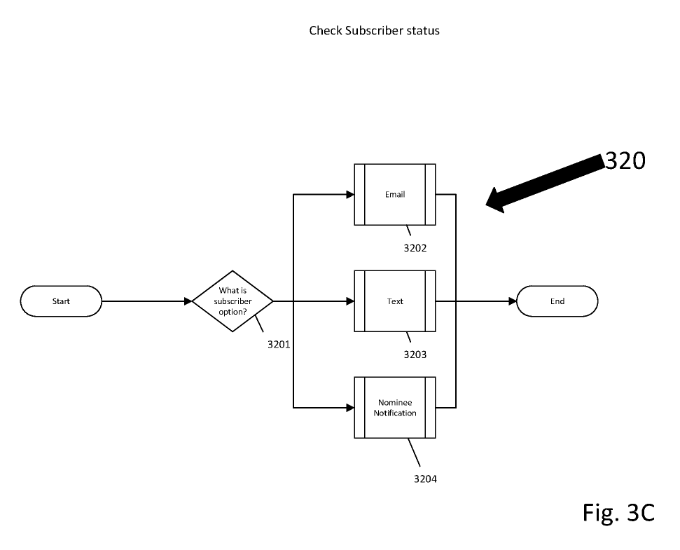

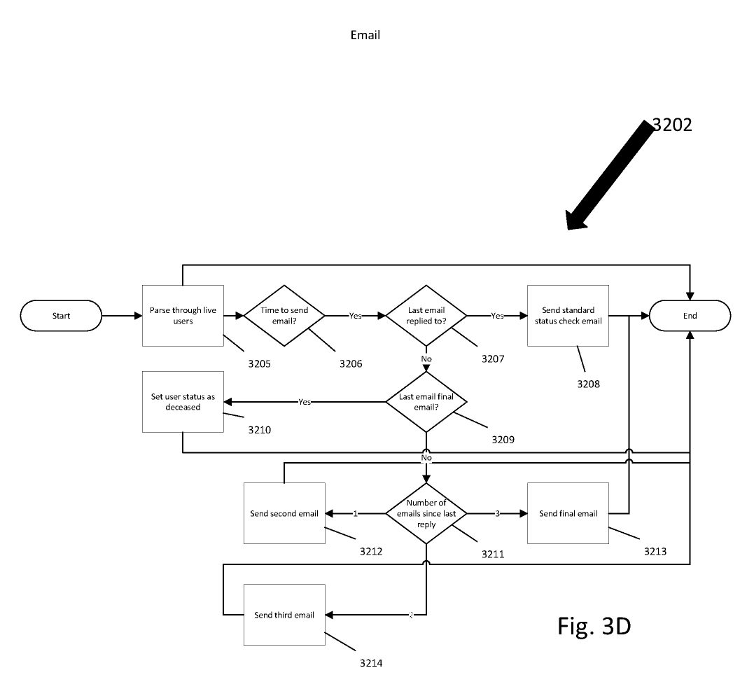

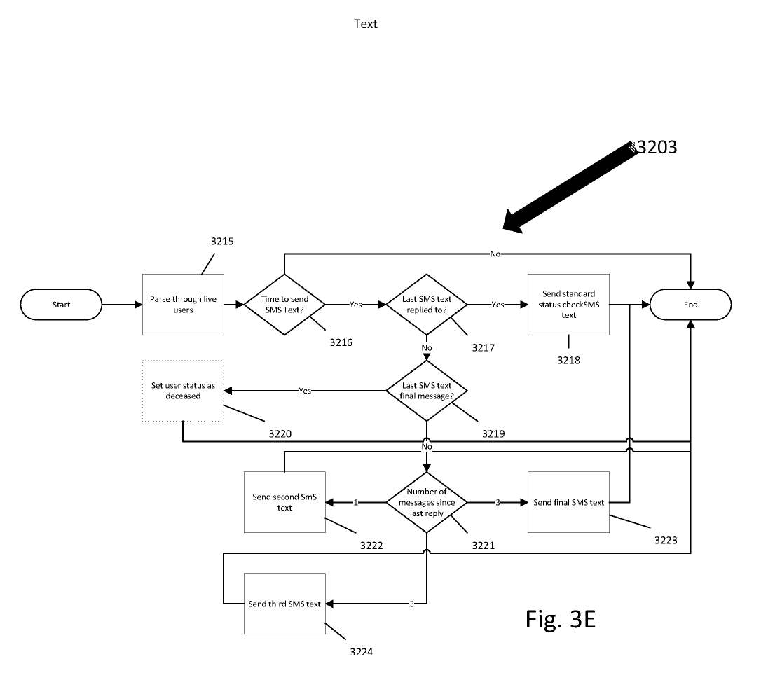

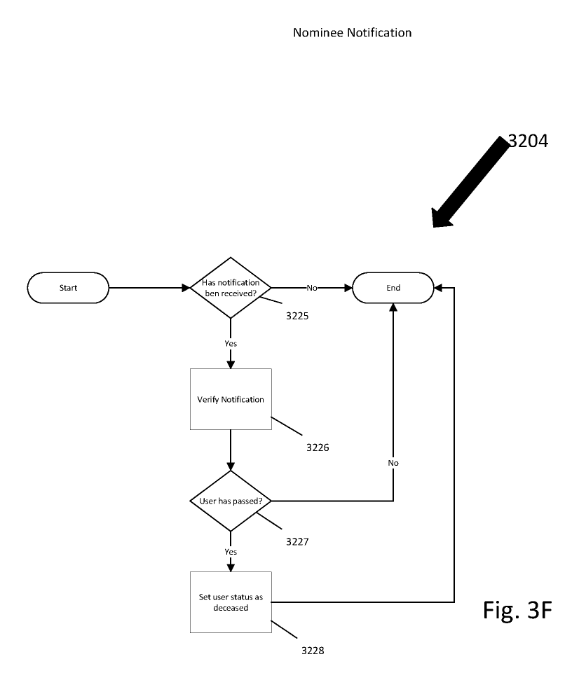

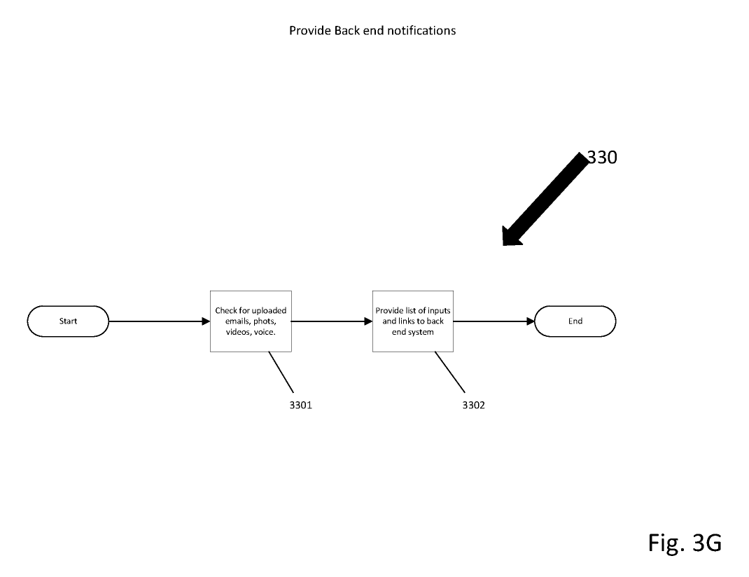

FIG. 3A shows the primary functional blocks of Automated System 300 of FIG. 1, which includes Check for Emails to be Sent Block 310, Check Subscriber status Block 320, and Provide Back End Notifications Block 330.

Check for Emails to be Sent Block 310 is shown in further detail in FIG. 3B. At Block 3101, Automated System 300 scans through users marked as deceased for the dates of emails to be sent. If there are emails to be sent (Block 3102), then a determination is made at Block 3103 as to whether the intended recipient is receiving those emails (i.e., has not turned off the delivery of messages). If the intended recipient is receiving emails, then the date corresponding to the email is sent with a link at Block 3104.

FIG. 3C illustrates Check Subscriber status Block 320 of FIG. 3A in further detail. Subscriber options at decision Block 3201 include email (Block 3202), text (Block 3203), and nominee notification (Block 3204). Email Block 3202 is shown in further detail in FIG. 3D, Text Block 3203 is shown in further detail in FIG. 3E, and Nominee Notification Block 3204 is shown in further detail in FIG. 3F.

As shown in FIG. 3D, Email Block 3202 parses through the live users (Block 3205). If it is time to send an email (Block 3206), then a determination is made as to whether the last email was replied to (Block 3207). If so, then at Block 3208, the standard check status email is sent. Otherwise, at Block 3209, a determination is made as to whether the last email was the final (warning) email. If so, the user status is set at deceased at Block 3210.

If the last email at Block 3209 was not the final (warning) email, then at Block 3211 a determination is made of the number of emails since the last reply. If only one email has already been sent, then at Block 3212 a second email is sent. If two emails have already been sent, then at Block 3214 a third email is sent. Otherwise, if three emails have already been sent, then a final email is sent at Block 3213.

FIG. 3E illustrates Text Block 3203 of FIG. 3C in further detail. The system parses through the live users (Block 3215). If it is time to send an SMS text (Block 3216), then a determination is made as to whether the last SMS text was replied to (Block 3217). If so, then at Block 3218, the standard check status check SMS text is sent. Otherwise, at Block 3219, a determination is made as to whether the last SMS text was the final (warning) SMS text. If so, the user status is set at deceased at Block 3220.

If the last SMS text at Block 3219 was not the final (warning) SMS text, then at Block 3221 a determination is made of the number of SMS texts since the last reply. If only one SMS text has already been sent, then at Block 3222 a second SMS text is sent. If two SMS texts have already been sent, then at Block 3224 a third SMS text is sent. Otherwise, if three

FIG. 3F shows Nominee Notification Block 3204 of FIG. 3C in further detail. At Block 3225, a determination is made as to whether a notification has been received. If so, the notification is verified at Block 3226. If the user has passed at Block 3227, then the user status is set as deceased at Block 3228.

Provide Back End Notifications Block 330 of FIG. 3A is shown in further detail in FIG. 3G. The system checks for uploaded emails, photos, videos, and voice at Block 3301. A list of inputs an links obtained at Block 3301 is provided to the back end system at Block 3302.

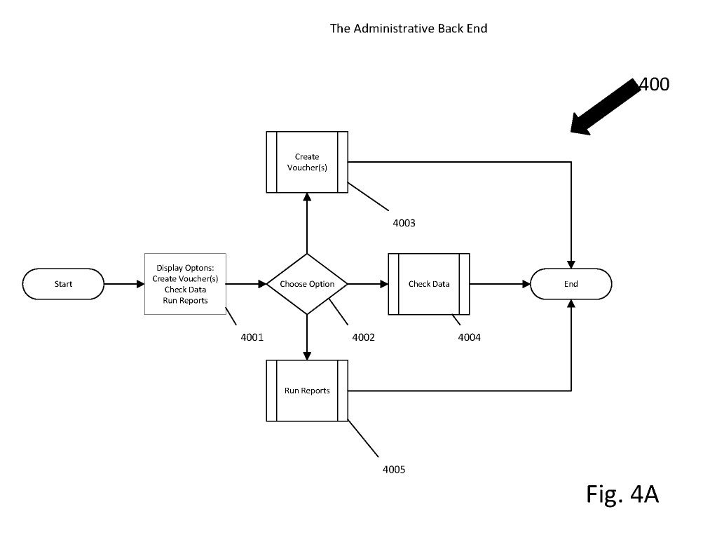

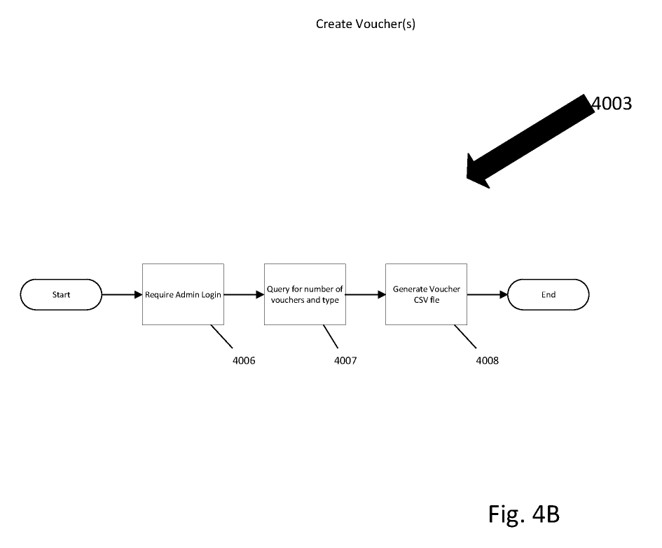

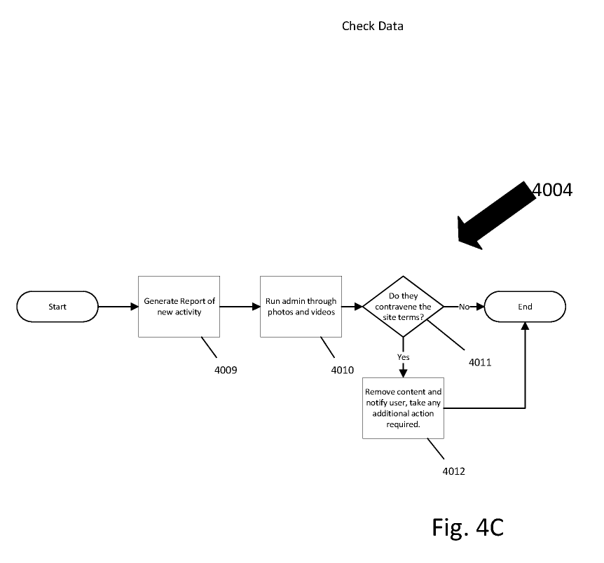

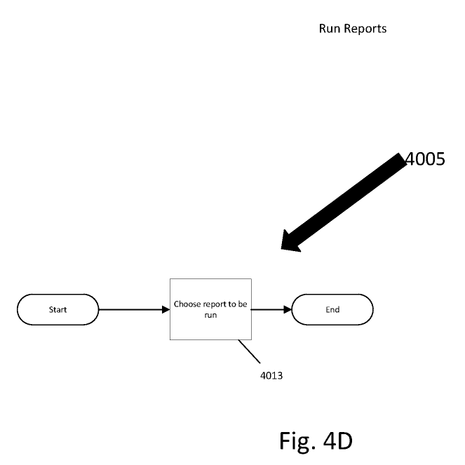

FIG. 4A depicts Administrative Back End Subsystem 400 of FIG. 1 in further detail. At Block 4001, options are displayed for the administrator, including create vouchers (Block 4003), check data (Block 4004), and run reports (Block 4005). The administrator chooses an option at decision Block 4002.

Create Vouchers Block 4001 is shown in further detail in FIG. 4B. The administrator logs in at Block 4006 and, in response to a query, enters a number of vouchers and type at Block 4007. The system generates the requested vouchers at Block 4008

Check Data Block 4004 of FIG. 4A is shown in further detail in FIG. 4C. A report of new activity is created for the administrator at Block 4009. The administrator is run through the new activities at Block 4010 and the administrator determines whether any of the new activities contravene the terms of use of the system (Block 4011). Any content that contravenes the terms of use is removed, the user is notified, and any additional action is taken, as required (Block 4012).

Run Reports Block 4005 of FIG. 4A is shown in FIG. 4D, where the administrator chooses a report to run at Block 4013.

Although the invention has been described with reference to specific embodiments, these descriptions are not meant to be construed in a limiting sense. Various modifications of the disclosed embodiments, as well as alternative embodiments of the invention, will become apparent to persons skilled in the art upon reference to the description of the invention. It should be appreciated by those skilled in the art that the conception and the specific embodiment disclosed might be readily utilized as a basis for modifying or designing other structures for carrying out the same purposes of the present invention. It should also be realized by those skilled in the art that such equivalent constructions do not depart from the spirit and scope of the invention as set forth in the appended claims.

It is therefore contemplated that the claims will cover any such modifications or embodiments that fall within the true scope of the invention.

What is claimed is:

1. A system for periodically transmitting posthumous messages from an originator to a recipient operable to:
store a message from the originator to the recipient, the message selectively including a digital attachment;
store a selected date corresponding to an occasion for delivery of the stored message to the recipient when the originator is determined to be deceased; and
automatically transmit the stored message to the recipient on the selected date unless halted by the recipient.

2. A system for periodically transmitting posthumous messages from an originator to recipients operable to:
store at least one message from the originator to at least one recipient, the at least one message selectively including at least one digital attachment;
store at least one selected date corresponding to an occasion for delivery of the stored message to the at least one recipient when the originator is determined to be deceased; and
automatically transmit the at least one stored message to the at least one recipient annually on the selected date unless halted by the recipient.

3. The system of claim 1, wherein the digital attachment is selected from the group consisting of video, voice, graphic images, and photographs.

4. The system of claim 1, further comprising a verification system to determine passing of the originator.

5. The system of claim 4, wherein the verification system comprises a nominee who triggers message delivery.

6. The system of claim 4, wherein the verification system comprises a monthly message to the originator which must be responded to by a predetermined response period.

7. The system of claim 1, wherein the message is transmitted to the recipient annually on the selected date.

8. A system for periodically transmitting posthumous messages from an originator to a recipient comprising:
a front end web interface subsystem which accepts user inputs and sends messages to a recipient;
an automated system which receives data from and sends data to the front end web interface subsystem;
an administrative back end subsystem which provides administrator inputs to the automated system; and
a database with information from the originator, administrator, and the recipients.

9. The system of claim 8, wherein the user is an originator.

10. The system of claim 8, wherein the user is a recipient.
